(19) United States
(12) Patent Application Publication
(10) Pub. No.: US 2023/0294960 A1
(43) Pub. Date: Sep. 21, 2023

(54) ELEVATOR

(71) Applicant: Kone Corporation, Helsinki (FI)

(72) Inventors: Matti RASANEN, Helsinki, FL (US); Ari Kattainen, Helsinki, FL (US); Juha Helenius, Helsinki, FL (US)

(73) Assignee: Kone Corporation, Helsinki (FI)

(21) Appl. No.: 18/323,078

(22) Filed: May 24, 2023

Related U.S. Application Data
(63) Continuation of application No. PCT/EP2021/084189, filed on Dec. 3, 2021.

(30) Foreign Application Priority Data
Dec. 7, 2020 (EP) 20212148.9

(51) Int. Cl. B66B 5/12; B66B 5/06; B66B 1/42; B66B 5/02; B66B 3/00; B66B 5/00

(52) U.S. Cl. CPC B66B 5/12; B66B 5/06; B66B 1/42; B66B 5/027; B66B 3/002; B66B 5/0018

(57) ABSTRACT

The car is connected to the counterweight with a hoisting member and further with a free fall protection member passing over at least two free fall protection pulleys provided with at least one free fall protection brake, which is controlled by a free fall protection controller. The pre-tensioning of the free fall protection member is at least 50% smaller than the pre-tensioning of the hoisting member. The free fall protection member is formed of at least one cogged belt. Each free fall protection pulley is formed of a cogged pulley mating with the cogged belt.

### CROSS-REFERENCE TO RELATED APPLICATION

This application is a continuation of PCT International Application No. PCT/EP2021/084189 which has an International filing date of Dec. 3, 2021, and which claims priority to European Patent Application No. 20212148.9 filed Dec. 7, 2020, the entire contents of both of which are incorporated herein by reference.

### FIELD

The invention relates to an elevator.

### BACKGROUND

An elevator may typically comprise a car, an elevator shaft, hoisting machinery, a hoisting member, and a counterweight. A separate or an integrated car frame may surround and support the car. The hoisting machinery may be positioned in a machine room or in the shaft. The hoisting machinery may comprise a drive, an electric motor, a traction sheave, and a machinery brake. The hoisting machinery may move the car in a vertical direction upwards and downwards in the vertically extending elevator shaft. The frame may be connected to the counterweight with the hoisting member passing over the traction sheave. The frame may further be supported with guiding means on guide rails extending along the height of the shaft. The guide rails may be supported with fastening brackets on the side wall structures of the shaft. The guiding means may engage with the guide rails and keep the car in position in the horizontal plane when the car moves upwards and downwards in the elevator shaft. The counterweight may be supported in a corresponding way on guide rails supported on the wall structure of the shaft. The elevator car may transport people and/or goods between the landings in the building. The elevator shaft may be formed so that the wall structure is formed of solid walls or so that the wall structure is formed of an open steel structure.

A requirement in elevator safety regulations is that elevators should be provided with a free fall protection system. Small elevators in low buildings may typically be provided only with a safety gear in connection with the car. Elevators in high buildings and elevators having accessible spaces below the shaft, should be provided with a safety gear in connection with the car and a safety gear in connection with the counterweight. An overspeed governor sheave, a safety gear and an overspeed governor (OSG) rope connecting the overspeed governor sheave and the safety gear have traditionally been used as a free fall protection system in elevators. The OSG rope runs over the OSG sheave in a top portion of the shaft and a lower tension pulley in a bottom portion of the shaft. The OSG rope is traditionally tightened with the lower tension pulley. The inertia of the rotating parts of the OSG and the OSG rope may, however, cause problems in fast elevators. An abrupt emergency stop by machinery brakes together with the above mentioned inertia may cause an unintentional activation of the safety gear.

The weight of the OSG rope will already as such cause a problem in high-rise buildings.

An OSG rope runs close to the stationary structures in the shaft and the tension of the OSG rope is distinctly less than that of the hoisting ropes.

Swaying and bending of the building may cause the OSG rope to become tangled in the shaft structures. In areas that are prone to excessive building sway, due e.g. to strong winds or earthquakes, operation of the elevators is interrupted if the building sway exceeds a safety limit.

The gripping of the safety gears on the guide rails must be considered when dimensioning the guide rails. This may increase the dimensions of the guide rails compared to a situation in which only the ride comfort, the horizontal accelerations and the uneven load of the car must be considered.

Prior art solutions exist in which the OSG sheave at the top of the shaft and the OSG rope loop have been replaced with a static OSG rope and an OSG located in connection with the car and operating the safety gear directly. A static OSG rope solves the problem of the rope inertia and partially also the problem relating to the swaying OSG rope. The safety gear may also, as a further alternative, be electrically activated. The electrically activated safety gear solves the problems relating to the OSG rope. Such a prior art solution requires, however, that accumulators are positioned in the car so that the OSG may be operated also in case there is a black-out. Furthermore, it may be impossible to release the safety gear with an electrical control if the car cable has been damaged.

### SUMMARY

An object of the present invention is an elevator provided with a novel free fall protection system and a method for controlling an elevator.

The elevator according to the invention is defined in claim 1.

The method for controlling an elevator according to the invention is defined in claim 12.

The free fall protection member does not in normal operation carry any significant part of the load of the car and the counterweight. The load of the car and the counterweight is in normal operation carried by the hoisting member. This situation can be achieved by having a lower pre-tensioning in the free fall protection member compared to the pre-tensioning in the hoisting member. The pre-tensioning of the free fall protection member need only be such that the free fall protection member is kept in its track on the free fall protection pulleys. The car and the counterweight are fully supported by the free fall protection member only in a situation in which the hoisting member fails.

The free fall protection system eliminates the overspeed governor rope and the problems associated with this.

The free fall protection system eliminates further the safety gears of the car and of the counterweight. The frame i.e. the sling of the car may thus be dimensioned for a deceleration of e.g. 0.5G instead of the normal 1G.

The construction of the guide rails may also be lighter as there will be no safety gears gripping the guide rails.

The problem of the guide rails falling on the jack-bolts when the safety gears are activated is thus also eliminated in the invention.

The situation in which a separate free fall protection member connects the car and the counterweight over separate free fall protection pulleys, wherein the free fall protection member is formed of at least one cogged belt and the free fall protection pulleys are provided with mating cogs eliminates the possibility that the free fall protection member could slip on the free fall protection pulleys. The shape-locking between the free fall protection member and the free fall protection pulleys makes it possible to achieve protection in both directions of the car with the free fall protection system.

The situation in which the free fall protection brake acts on the free fall protection pulley makes it easier to control the brake force compared to a situation in which the free fall protection brake acts directly on the free fall protection member.

A jump preventing lock-down apparatus is normally required in elevators having a rated speed over 3 m/s. The lock-down apparatus may be avoided altogether when the deceleration of the car is monitored and controlled automatically at the shaft ends, wherein buffer run at excessive speeds is eliminated. The machinery brake and the free fall protection brake may be dimensioned so that the deceleration of the car and/or the counterweight stays within the safe limits in terms of passenger safety and elevator safety regulations.

The car may always be moved to a landing from the machine room. There is no need to consider a situation in which the car and/or the counterweight cannot be moved because the safety gears cannot be opened so there will be no need for rescuing people from one car to another.

The free fall protection system may be used to control unintentional car movement at a landing. The car may unintentionally move upwards or downwards on a landing when the doors are open because of a change in the load in the car. It is difficult to realize relevelling of the car on a landing as a response to unintended car movement on the landing when the machine brakes are activated. Activated machinery brakes will prevent relevelling of the car at the landing. The invention makes it possible to realize the unintended car movement prevention on the landing with the free fall protection brakes. The machinery brakes may be de-activated and the free fall protection brakes may be activated when the car has stopped at the landing. The pre-tensioning of the free fall protection member is less than the pre-tensioning of the hoisting member. It is thus possible to immediately relevel the car at the landing with the hoisting machinery when the machinery brakes are open and the free fall protection brakes are closed. The lightly loaded free fall protection member will stretch during the relevelling of the car so that relevelling of the car is possible. The free fall protection member may also be attached to the car and to the counterweight via springs. The springs will further contribute to the stretching of the free fall protection member. The unintended car movement prevention is thus maintained during the relevelling of the car. The safety level of the elevator is thus maintained at a high level during the relevelling of the car.

The free fall protection system may be used to secure that the maximum allowable deceleration of 1 G is not exceeded when the car approaches terminal landings. The elevator safety regulations require that the normal slowdown of the car must be monitored at terminal landings in shafts with a reduced buffer stroke. A low pit below the lowermost landing requires that only short buffers be used in the pit. It is not possible to drive at rated speed on the buffers as the deceleration would then exceed the maximum allowed value of 1 G. A maximum speed or a minimum deceleration is set for the car approaching the lowermost landing. The free fall protection system may be used as a back-up system to increase the safety in approaching terminal landings having a reduced buffer stroke. The free fall protection controller makes sure that the car decelerates as required when the car approaches an end of the shaft. The free fall protection controller may assist in the deceleration of the car with the free fall protection brakes. This will add redundancy and/or another protection layer to the elevator. This will further make it possible to adjust the deceleration rate more easily. There will be no belt slipping when braking with the free fall protection brakes due to the cogged belt running on the cogged pulleys in the free fall protection system.

The free fall protection system may be used to control the deceleration of the car. This may be done by using the brakes in the free fall protection in parallel with the machinery brakes of the elevator. An acceleration sensor positioned in connection with the car may be used as input for the control of the machinery brakes and the free fall protection brakes. The maximum deceleration for a car transporting people is 1 G. The invention makes it possible to produce a constant portion of the deceleration torque with the machinery brakes and an adjustable portion of the deceleration torque with the free fall protection brakes so that the maximum deceleration of 1 G of the car is not exceeded in any circumstances. It is difficult to manage all load situations and/or all imbalance situations only with the machinery brake so that the braking distance and the maximum deceleration stay within safe limits. The adjustable deceleration torque achieved with the free fall protection brakes makes it much easier to dimension the machinery brakes. The free fall brakes are controlled based on the acceleration sensor in the car. The braking torque of the free fall brakes may be controlled by producing brake pulses to the free fall brakes. This may be done by using pulse-width-modulation. A hydraulic system may be used to control the free fall protection brakes based on the pulse-width-modulation control. The free fall protection brakes may be controlled in accordance with an anti-lock braking system (ABS). The ABS system operates by preventing the free fall protection pulley from locking up during braking. The deceleration of the free fall protection pulley may thus be adjusted to a desired level.

The free fall protection system may be used to move the car in a situation when the car has become stuck between landings. Various reasons may cause the car to become stuck between landings. There may be a black-out in the power supply of the elevator and the stand-by battery may be discharged. There may be a bearing failure in the machinery or in the deflection pulleys of the elevator resulting in an overload in the motor current. The overcurrent protection of the motor will thus be activated disconnecting the power supply to the motor. There may be a failure preventing releasing of the machinery brake. The use of the inventive free fall protection system provides a solution for the situation in which the car is stuck between landings. A mechanical interface e.g. a gear may be connected to one of the free fall protection pulleys. The mechanical interface may on the other hand be connected to a motor for driving the free fall protection pulley. Another possibility is to connect the mechanical interface to a simple lever. The car may thus be moved with the motor or the lever to the nearest landing. The free fall protection pulley may be positioned within the machine room or in the vicinity of the machine room so that the operation may be carried out from within the machine room. The traction of the cogged free fall protection member on the cogged free fall pulley is enough to overcome the traction of the hoisting member on the traction pulley in case the traction sheave does not move.

The free fall protection system may be provided with a rescue brake opening. A rescue brake opening bottom may be provided at the Maintenance Access Panel (MAP) or in the machine room for opening of the free fall protection brakes and the machinery brakes. An encoder may be used at the free fall protection pulley for monitoring the speed and/or the acceleration and/or the distance travelled. The free fall protection controller controls the speed and/or the acceleration of the car and, in case of an excessive speed or acceleration, applies the free fall protection brakes. A test button for each the free fall protection brake may further be provided in connection with the rescue brake opening button. The test button opens the machinery brakes and the other free fall protection brakes and engages only the free fall protection brake to be tested. The free fall protection brake may then be tested by applying a test torque to the free fall protection pulley provided with the free fall protection brakes.

The free fall protection system may be used to help in manual rescue operation of the car. The rescue operation requires especially, in case of a heavy elevator, manual operation at the machine room. The rescue operator needs to check visually the position of the car to hit the landing door zone, The smooth backside of the free fall protection member may be provided with markings for each landing and for the upper limit and the lower limit of the corresponding door zone. This marking can be made visible in the machine room to the operator e.g. by arranging lights in the position in which the operator executes the manual rescue operation. The marking may be provided on the free fall protection member during commissioning of the elevator with half of the rated load in the car to even out error margins due to different loads.

The free fall protection system may be used to detect slipping of the hoisting member. The hoisting member may slip e.g. because of oil on the traction sheave and/or on the hoisting member. The cogged free fall protection belt cannot slip on the cogged free fall protection pulley. This fact may be used for detecting slipping of the hoisting ropes. A first encoder may be positioned at the axle of the traction shave. A second encoder may be positioned at the free fall protection pulley. The output of the first encoder may be compared to the output of the second encoder. Any discrepancy between the output signal of the two encoders will be an indication of hoisting rope slipping. The car may be driven to the closest landing, the doors may be opened and the car may be taken out of use when rope slipping is detected. The fault condition may be stored into a memory and sent to a cloud for a maintenance call.

The speed of the free fall protection member and/or the speed of the car and/or the speed of the counterweight and/or the speed of any rotating sheave or pulley in the system may be measured with a speed detector. Any kind of speed detector may be used in this connection. The speed detector may be based on electronic devices e.g. it may be based on one or more acceleration sensors or it may be based on encoder data. The encoder may be used to measure the rotation speed of a sheave or pulley in the system. The speed detector may on the other hand be based on mechanical devices e.g. a roller acting on the car guide rail.

The free fall protection system may further comprise a speed detector measuring the speed and/or the acceleration-deceleration directly or indirectly of the car and/or the counterweight, whereby the free fall speed controller is arranged to activate the at least one free fall protection brake device when an abnormal speed and/or acceleration-deceleration is detected.

The free fall protection system may be used in connection with any kind of elevators. The elevator free fall protection system is especially suitable to be used in high-rise buildings in which the elimination of the OSG rope, the safety gear and the anti-rebound device is a big advantage. There is no generally accepted definition of the term “high-rise building”, but one could consider that buildings having a height of more than 50 meter could be called high-rise building. The height of high-rise buildings could be several hundred meters.

The hoisting member in an elevator may be formed of round or of flat ropes. The hoisting member may be of steel and/or of polymer. Flat ropes made of carbon fibres sealed in high-friction polymer may advantageously be used as hoisting ropes in elevators in high-rise buildings. The weight of such flat ropes made of carbon fibres sealed in high-friction polymer is much less than the weight of corresponding steel ropes. Such flat ropes made of carbon fibres sealed in high-friction polymer are sold e.g. under the trade name KONE UltraRope®.

### DRAWINGS

The invention will in the following be described in greater detail by means of preferred embodiments with reference to the attached drawings, in which

FIG. 1 shows a side view of an elevator, FIG. 2 shows the free fall protection system in an elevator applying a 1:1 suspension ratio,

FIG. 3 shows the free fall protection system in an elevator applying a 2:1 suspension ratio,

FIG. 4 shows a first additional feature in connection with the free fall protection system,

FIG. 5 shows a second additional feature in connection with the free fall protection system,

FIG. 6 shows a third additional feature in connection with the free fall protection system,

FIG. 7 shows a free fall protection member provided with markings.

### DETAILED DESCRIPTION

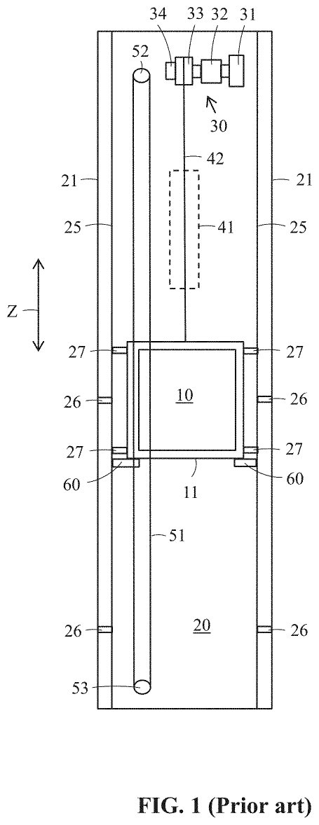

FIG. 1 shows a side view of a prior art elevator.

The elevator may comprise a car 10, an elevator shaft 20, hoisting machinery 30, a hoisting member 42, and a counterweight 41. A separate or an integrated car frame 11 may surround and support the car 10.

The hoisting machinery 30 may be positioned in a machine room or in the shaft 20. The hoisting machinery may comprise a drive 31, an electric motor 32, a traction sheave 33, and a machinery brake 34. The hoisting machinery 30 may move the car 10 in a vertical direction Z upwards and downwards in the vertically extending elevator shaft 20. The machinery brake 34 may stop the rotation of the traction sheave 33 and thereby the movement of the elevator car 10.

The hoisting member 42 may be formed of one or more hoisting ropes or hoisting belts running in parallel.

The car frame 11 may be connected to the counterweight 41 with the hoisting member 42 passing over the traction sheave 33. The car frame 11 may further be supported with guiding means 27 at guide rails 25 extending in the vertical direction in the shaft 20. The guiding means 27 may comprise rollers rolling on the guide rails 25 or gliding shoes gliding on the guide rails 25 when the car 10 is moving upwards and downwards in the elevator shaft 20. The guide rails 25 may be attached with fastening brackets 26 to the side wall structures 21 in the elevator shaft 20. The guiding means 27 keep the car 10 in position in the horizontal plane when the car 10 moves upwards and downwards in the elevator shaft 20. The counterweight 41 may be supported in a corresponding way on guide rails that are attached to the wall structure 21 of the shaft 20.

The car 10 may transport people and/or goods between the landings in the building. The elevator shaft 20 may be formed so that the wall structure 21 is formed of solid walls or so that the wall structure 21 is formed of an open steel structure.

The figure shows further a prior art speed limiter system based on a mechanical pulley and a rope system. The system comprises an OSG sheave 52 mounted e.g. in the upper part of the elevator shaft 20, a tensioning pulley 53 mounted in the lower part of the elevator shaft 20 and an OSG rope 51 fitted to run in a substantially tight closed loop around the OSG sheave 52 and the tensioning pulley 53. A mechanical linkage system may connect the OSG rope 51 to the safety gears 60. The OSG rope 51 runs around the OSG sheave 52 and the tensioning pulley 53 when the car 10 is moving. If the elevator car 10 and thereby also the OSG rope 51 move at an excessive speed, then the rotation of the OSG sheave 52 in the upper part of the elevator shaft 20 is stopped by a mechanism activated e.g. by centrifugal force and at the same time the OSG rope 51 also stops moving. The stationary OSG rope 51 will exert a pull on the mechanical linkage system at the car that is still moving, causing the safety gears 60 to grip the car guide rails 25, thereby stopping the car 10.

FIG. 2 shows a schematic presentation of a free fall protection system in an elevator applying a 1:1 suspension ratio.

The left-hand side of the figure shows the hoisting member 42 connecting the car 10 with the counterweight 41 over the traction sheave 33. The hoisting member 42 runs further from the traction sheave 33 via a first diverting pulley 35 to the counterweight 41. The suspension ratio of the hoisting member 42 is 1:1. The traction sheave 33 may be positioned vertically above the car 10. The first diverting pulley 35 may be positioned vertically above the counterweight 41. The machinery brakes 34 may act on any rotation part in the hoisting machinery 30 comprising the drive 31, the electric motor 32, and the traction sheave 33 (see FIG. 1).

The right-hand side of the figure shows the inventive elevator free fall protection system 100. The elevator free fall protection system 100 comprises a free fall protection member 110 connecting the car 10 and the counterweight 41. The free fall protection member 110 runs from the car 10 over two free fall protection pulleys 120, 130 to the counterweight 41. The suspension ratio of the free fall protection member 110 is 1:1. The first free fall protection pulley 120 may be positioned vertically above the car 10 and the second free fall protection pulley 130 may be positioned vertically above the counterweight 41.

The free fall protection member 110 may be attached to the sling 11 of the car 10 with a first termination device 160 and to the counterweight 41 with a second termination device 170. The first termination device 160 and the second termination device 170 may be separate and independent in relation to the corresponding termination devices of the hoisting member 42.

The traction pulley 33 may further be provided with at least one machinery brake 34A, 34B. Each of the machinery brakes 34A, 34B may be controlled individually with a machinery brake controller 210. The machinery brake controller 210 may further be controller by the main controller 300 of the elevator. The traction pulley 33 may further be provided with a speed detector e.g. an encoder 200. The output of the encoder 200 may be connected to the main controller 300 of the elevator.

One of the free fall protection pulleys 120, 130 may be provided with at least one free fall protection brake 140, 150. The at least one free fall protection brake 140, 150 may be arranged in connection with the first free fall protection pulley 120 being positioned vertically above the car 10. The embodiment in the figure comprises two free fall protection brake devices 140, 150. The free fall protection brake devices 140, 150 act on the first free fall protection pulley 120 in the figure, but they could as well act on the second free fall protection pulley 130. Each of free fall protection brake devices 140, 150 may be controlled individually with a free fall protection controller 260. The free fall protection controller 260 may further be controlled by the main controller 300 of the elevator. One of the free fall protection pulleys 120, 130 may further be provided with an encoder 250. The first free fall protection pulley 120 is in this embodiment provided with the encoder 250. The output of the encoder 250 may be connected to the main controller 300 of the elevator or to the free fall protection controller 260 of the elevator or to both.

The use of two free fall protection brake devices 140, 150 is an advantageous embodiment, but the invention could be realized with only one free fall protection brake device 140, 150. The use of two free fall protection brake devices 140, 150 increases the safety compared to the use of only one free fall protection brake device 140, 150. The use of two free fall protection brakes 140, 150 makes it also easier to control the deceleration of the car 10 in the downwards and in the upwards direction by using a delay between the closing of the first and the second free fall protection brake 140, 150.

The two free fall protection brake devices 140, 150 are controlled with the free fall protection controller 260.

The operation of the free fall protection brakes 140, 150 may be based on electromagnets and springs. The springs may press the free fall protection brakes 140, 150 against the free fall protection pulley 120 for engaging the free fall protection brakes 140, 150. The electromagnets may, when energized, act against the springs and pull the free fall protection brakes 140, 150 away from free fall protection pulley 120 for releasing the free fall protection brakes 140, 150.

An emergency power supply 400 for supplying power to the free fall protection controller 260 and to the free fall protection brake devices 140, 150 may further be provided. The emergency power supply 400 may provide power to the free fall protection brake devices 140, 150 during a black-out eliminating activation of the free fall protection brake devices 140, 150 during the black-out.

The free fall protection pulleys 120, 130, the free fall protection brake devices 140, 150, the free fall protection controller 260 and the emergency supply device 400 may be positioned in the machine room in an elevator provided with a machine room. The traction sheave 33 may also be positioned in the machine room.

The free fall protection pulleys 120, 130, the free fall protection brake devices 140, 150, the free fall protection controller 260 and the emergency supply device 400 may on the other hand be positioned in an upper end of the shaft 20 in an elevator lacking a machine room. The traction sheave 33 may also be positioned in the upper end of the shaft 20.

The car 10 and the counterweight 41 are in a normal operational situation of the elevator supported only by the hoisting member 42. The free fall protection member 110 may be pre-tensioned so that the car 10 and the counterweight 41 are supported by the free fall protection member 110 only in a situation in which the hoisting member 42 support fails. The hoisting member 42 support could fail e.g. in a case in which the hoisting member 42 breaks or the rope termination of the hoisting member 42 breaks.

The hoisting member 42 may be dimensioned so that the safety factor of the hoisting member 42 is at least 12, whereby the safety regulations of an elevator are fulfilled.

The free fall protection member 110 may on the other hand be dimensioned so that the safety factor of the free fall protection member 110 is 2 to 8, advantageously 3 to 6. The safety factor of the free fall protection member 110 may thus be much lower than the safety factor of the hoisting member 42. The safety factor of the free fall protection member 110 may be in the range of 25% to 50% of the safety factor of the hoisting member 42.

The pre-tensioning of the free fall protection member 110 may be less than 50%, preferably less than 10% of the pre-tensioning of the hoisting member 42. A considerably lower pre-tension of the free fall protection member 110 compared to the pre-tension of the hoisting member 42 will ensure that only the hoisting member 42 carries to load of the car 10 and the counterweight 41 during normal operation of the elevator.

The hoisting member 42 passes from the car 10 over the traction sheave 33 and the deflection pulley 35 to the counterweight 41. The suspension ratio of the hoisting member 42 is thus 1:1 in this embodiment of the elevator. The car 10, the counterweight 41, and the hoisting member 42 all move with the same speed in this embodiment.

The free fall protection member 110 passes from the car 10 over the free fall protection pulleys 120, 130 to the counterweight 41. The suspension ratio of the free fall protection member 110 is thus 1:1 in this embodiment.

The routing of the free fall protection member 110 between the car frame 11 and the counterweight 41 may be independent of that of the hoisting member 42.

Each of the free fall protection brake devices 140, 150 may be formed of a disc brake or a drum brake or a belt brake or a wedge brake or of any combination of these. Each of the free fall protection brake devices 140, 150 may further be operated electrically or pneumatically or hydraulically or with any combination of these.

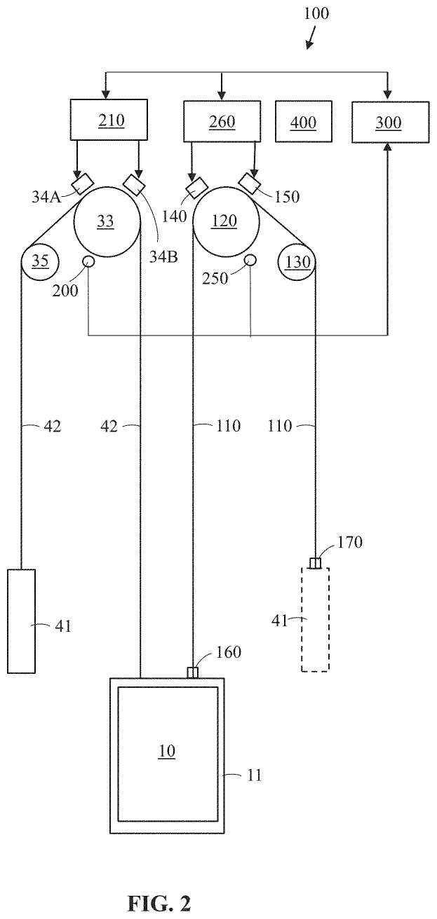

FIG. 3 shows a schematic presentation of a free fall protection system in an elevator applying a 2:1 suspension ratio.

Opposite ends of the hoisting member 42 may be attached in fastening points F1, F2 to the roof of the shaft 20. The hoisting member 42 may first run from the first fastening point F1 vertically downwards on a first side of the car 10 to the bottom of the car 10. The hoisting member 42 runs then horizontally under the car 10 supported by two deflection pulleys 71, 72 which are supported on the bottom of the sling 11. The hoisting member 42 runs then again vertically upwards on a second opposite side of the car 10 to the traction sheave 33 positioned in an upper end of the shaft 20. The hoisting member 42 runs then over the traction sheave 33 and then again downwards to a third deflection pulley 73 and finally vertically upwards to the second fastening point F1. The counterweight 41 is supported on the third deflection pulley 73. The counterweight 41 may be supported on a rotation axle of the third deflection pulley 73. The machinery brakes 34 may act on any rotation part in the hoisting machinery 30 comprising the drive 31, the electric motor 32, and the traction sheave 33 (see FIG. 1).

The traction sheave 33 may further be provided with at least one machinery brake 34A, 34B. Each of the machinery brakes 34A, 34B may be controlled individually with a machinery brake controller 210. The machinery brake controller 210 may further be controller by the main controller 300 of the elevator. The traction sheave 33 may further be provided with a speed detector e.g. an encoder 200. The output of the encoder 200 may be connected to the main controller 300 of the elevator.

The elevator free fall protection system 100 comprises a free fall protection member 110 connecting the car 10 and the counterweight 41. The free fall protection member 110 runs from the car 10 over two free fall protection pulleys 120, 130 to the counterweight 41. The first free fall protection pulley 120 may be positioned vertically above the car 10 and the second free fall protection pulley 130 may be positioned vertically above the counterweight 41. The two free fall protection pulleys 120, 130 may be supported on the roof of the shaft 20. The traction sheave 33 may also be supported on the roof of the shaft 20.

The free fall protection member 110 may be attached to the sling 11 of the car 10 with a first termination device 160 and to the counterweight 41 with a second termination device 170. The first termination device 160 and the second termination device 170 may be separate and independent in relation to the corresponding termination devices of the hoisting member 42.

One of the free fall protection pulleys 120, 130 may be provided with at least one free fall protection brake 140, 150. The at least one free fall protection brake 140, 150 may be arranged in connection with the second free fall protection pulley 130 being positioned vertically above the counterweight 41. The embodiment in the figure comprises two free fall protection brake devices 140, 150. The free fall protection brake devices 140, 150 act on the second free fall protection pulley 130 in this figure, but they could as well act on the first free fall protection pulley 120. Each of the free fall protection brake devices 140, 150 may be controlled individually by a free fall protection controller 260. The free fall protection controller 260 may further be controlled by the main controller 300 of the elevator. One of the free fall protection pulleys 120, 130 may further be provided with a speed detector e.g. an encoder 250. The second free fall protection pulley 130 is in this embodiment provided with the encoder 250. The output of the encoder 250 may be connected to the main controller 300 of the elevator.

The use of two free fall protection brake devices 140, 150 is an advantageous embodiment, but the invention could be realized with only one free fall protection brake device 140, 150. The use of two free fall protection brake devices 140, 150 increases the safety compared to the use of only one free fall protection brake device 140, 150. The use of two free fall protection brakes 140, 150 makes it also easier to control the deceleration of the car 10 in the downwards and in the upwards direction by using a delay between the closing of the first and the second free fall protection brake 140, 150.

The two free fall protection brake devices 140, 150 are controlled with a free fall protection controller 260.

An emergency power supply 400 for supplying power to the free fall protection controller 260 and to the free fall protection brake devices 140, 150 may further be provided. The emergency power supply 400 may provide power to the free fall protection brake devices 140, 150 during a black-out eliminating activation of the free fall protection brake devices 140, 150 during the black-out.

The free fall protection pulleys 120, 130, the free fall protection brake devices 140, 150, the free fall protection controller 260 and the emergency supply device 400 may be positioned in the machine room in an elevator provided with a machine room. The traction sheave 33 may also be positioned in the machine room.

The free fall protection pulleys 120, 130, the free fall protection brake devices 140, 150, the free fall protection controller 260 and the emergency supply device 400 may on the other hand be positioned in an upper end of the shaft 20 in an elevator lacking a machine room. The traction sheave 33 may also be positioned in the upper end of the shaft 20.

The car 10 and the counterweight 41 are in a normal operational situation of the elevator supported only by the hoisting member 42. The free fall protection member 110 may be pre-tensioned so that the car 10 and the counterweight 41 are supported by the free fall protection member 110 only in a situation in which the hoisting member 42 support fails. The hoisting member 42 support could fail e.g. in a case in which the hoisting member 42 breaks or the rope termination of the hoisting member 42 breaks.

The hoisting member 42 may be dimensioned so that the safety factor of the hoisting member 42 is at least 12, whereby the safety regulations of an elevator are fulfilled.

The free fall protection member 110 may on the other hand be dimensioned so that the safety factor of the free fall protection member 110 is 2 to 8, advantageously 3 to 6. The safety factor of the free fall protection member 110 may thus be much lower than the safety factor of the hoisting member 42. The safety factor of the free fall protection member 110 may be in the range of 25% to 50% of the safety factor of the hoisting member 42.

The pre-tensioning of the free fall protection member 110 may be less than 50%, preferably less than 10% of the pre-tensioning of the hoisting member 42. A considerably lower pre-tension of the free fall protection member 110 compared to the pre-tension of the hoisting member 42 will ensure that only the hoisting member 42 carries to load of the car 10 and the counterweight 41 during normal operation of the elevator.

The hoisting member 42 passes from the first fastening point F1 around the car 10, over the traction sheave 33, over the third deflection pulley 73 to the second fastening point F2. The suspension ratio of the hoisting member 42 is thus 2:1 in this embodiment. The speed of the car 10 is only half of the speed of the traction sheave 33 and the hoisting rope 41. The weight hanging on the traction sheave 33 is on the other hand only half of the weight hanging on the traction sheave 33 in the embodiment shown in FIG. 2.

The free fall protection member 110 passes from the car 10 over the free fall protection pulleys 120, 130 to the counterweight 42. The suspension ratio of the free fall protection member 110 is thus 1:1 also in this embodiment.

Each of the free fall protection brake devices 140, 150 may be formed of a disc brake or a drum brake or a belt brake or a wedge brake or of any combination of these. Each of the free fall protection brake devices 140, 150 may further be operated electrically or pneumatically or hydraulically or with any combination of these.

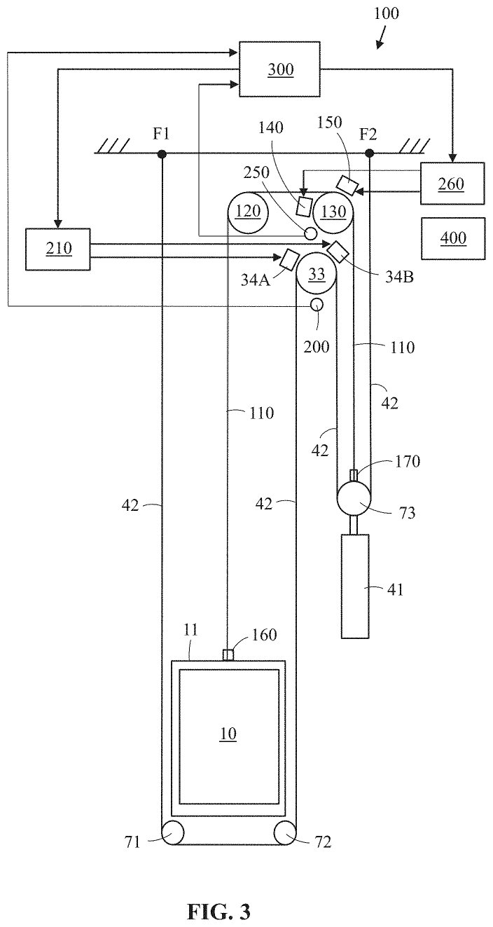

FIG. 4 shows a first additional feature in connection with the free fall protection system.

A mechanical interface 500 may be provided between the free fall protection system 100 and the hoisting machinery of the elevator. The mechanical interface 500 may be arranged between the shaft of the free fall protection pulley 120 and the shaft of the motor 32 driving the traction sheave 33. The mechanical interface 500 may be realized with a mechanical clutch. The position of the mechanical clutch 500 may be monitored with proximity switches. The proximity switches in connection with the mechanical clutch 500 are needed to eliminate normal operation of the elevator when the mechanical clutch 500 is activated i.e. the free fall member 110 is driven with the motor 32. An electrical opening of the machinery brakes 34A, 34B and the free fall protection brakes 140, 150 may further be provided in the system.

The elevator may be operated only in a Rescue Drive Mode (RDF) operation mode by moving the car slowly upwards or downwards. The RDF operation mode refers to an operation mode in which one or more safety circuits of the elevator are bypassed.

The car 10 could instead of being moved with the motor 32 via the mechanical clutch 500, be moved with a mechanical lever attached to the shaft of the free fall protection pulley 120. A mechanical clutch could be used between the mechanical lever and the shaft of the free fall protection pulley 120.

Another possibility to move the car 10 could be to use a chain block 510. A clamp 520 may be attached to the free fall protection member 110 in a position between the free fall protection pulleys 120, 130. The chain block 510 may be connected between the block and a stationary frame construction in the vicinity of the free fall protection pulleys 120, 130. The free fall protection member 110 and thereby also the car may thus be moved with the chain block 510. The chain block 510 is used manually and operation of the elevator in any mode is prohibited. The machine brakes 34A, 34B and the free fall protection brakes 140, 150 may be opened when the chain block 510 is used. There is no danger of a free fall of the car as the cogged free fall member 110 is mechanically locked to the cogged free fall protection pulleys 120, 130. The free fall protection brakes 140, 150 should, however, be activated if the speed and/or the acceleration of the car exceeds a predetermined threshold.

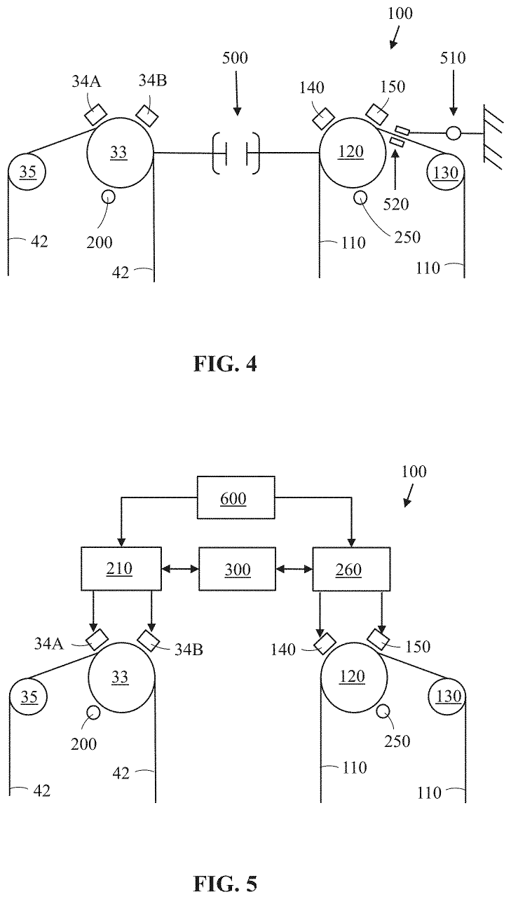

FIG. 5 shows a second additional feature in connection with the free fall protection system.

A rescue brake opening (RBO) system 600 may be realized in connection with the free fall protection system 100. The RBO system 600 may comprise control switches for controlling the machinery brakes 34A, 34B and the free fall protection brakes 140, 150 may be arranged in the machine room or in the Maintenance Access Panel (MAP).

The control switches of the RBO system 600 may be used to open the machinery brakes 34A, 34B and the free fall protection brakes 140, 150 in a rescue situation in which the car has been stuck between landings. The operation in a rescue situation is such that the machinery brakes 34A, 34B and the free fall protection brakes 140, 160 are opened electrically, wherein the car may move upwards or downwards in the shaft, pulled by the imbalance between the car 10 and the counterweight 41. The speed and/or the acceleration of the car may be monitored with an encoder 250 connected to the free fall pulley 120. If the speed and/or the acceleration of the car exceeds a predetermined threshold, then the machinery brakes 34A, 34B and the free fall protection brakes 140, 150 may engage automatically.

The control switches of the RBO system 600 may also be used when testing the brakes. The RBO system may comprise a switch for selecting the machinery brake 34A, 34B to be tested. The RBO system 600 may further comprise a press button for starting the test cycle. After the brake to be tested has been selected and the press button for starting the test cycle has been pressed, all other brakes will open and the brake to be tested remains closed. The motor 32 is then driven in both directions to make sure that the brake to be tested holds i.e. keeps the traction sheave 33 non-rotating. The results are recorded in a local or remote memory and the results are further displayed as numerical values. If the brake to be tested does not work properly, then the other brakes are closed to secure safety. It is also possible to test the free fall protection brakes 140, 150 in this way as the cogged free fall protection member 110 is mechanically locked to the cogged free fall protection pulley 120 and one end of the free fall protection member is connected to the car and the other end is connected to the counterweight. If the motor 32 is e.g. rotated in a downwards direction, the car cannot move as the free fall member prevents movement of the car as long as at least one free fall protection brake 140, 150 is closed.

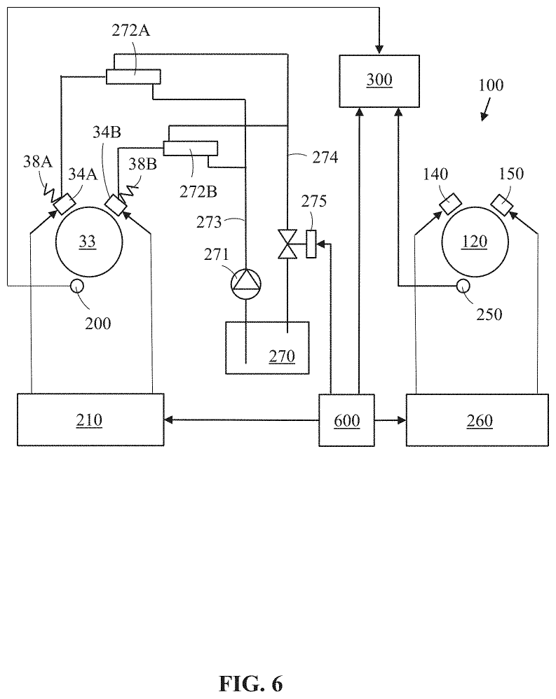

FIG. 6 shows a third additional feature in connection with the free fall protection system.

Big elevators provided with a big electric motor 32 may often use a hydraulic machinery brake operating system. The inventive free fall protection system 100 may naturally also be used in connection with hydraulic machinery brakes 34A, 34B.

A tank 270 may be provided in the vicinity of the hoisting machinery 30. The tank 270 may comprise hydraulic oil. A pump 271 may be arranged to pump oil from the tank 270 via a supply pipe 273 to two hydraulic cylinders 272A, 272B. Each of the hydraulic cylinders 272A, 272B is connected to a respective machinery brake 34A, 34B. The hydraulic cylinders 272A, 272B operate the respective machinery brake 34A, 34B. Each machinery brake 34A, 34B is loaded with a spring 38A, 38B. The spring 38A, 38B keeps the machinery brake 33A, 33B closed i.e. presses the braking surface of the machinery brake 34A, 34B against the traction sheave 33 preventing rotation of the traction sheave 33. The hydraulic cylinder 272A, 272B opens the machinery brake 34A, 34B against the spring force 38A, 38B when oil is pumped into the hydraulic cylinder 272A, 272B. The return pipe 274 is provided with a magnet valve 275 through which the oil may return to the tank 270. The pump 271 could be an electrically driven pump or a mechanically driven pump.

The figure shows two hydraulic cylinders 272A, 272B, but only one return pipe 274 and one magnetic valve 275 for clarity reasons. There are in fact two separate return pipes 274, wherein each return pipe 274 is provided with a magnetic valve 275. Each machinery brake 34A, 34B may thus be controlled individually.

The testing of the brakes 34A, 34B may be fully automated if an electrically driven pump 271 is used.

The RBO system 600 may be provided with respective control switches and/or control buttons for testing the brakes 34A, 34B. Each of the machinery brakes 34A, 34B may be opened by pumping oil into the cylinders 272A, 272B and keeping the return valve 275 of the machinery brake 34A, 34B that is to be opened closed. The cylinder 272A, 272B having the return valve 275 closed will then open the machinery brake 34A, 34B that is connected to said cylinder 272A, 272B.

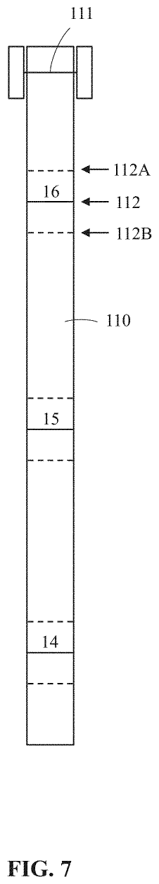

FIG. 7 shows a free fall protection member provided with markings.

The smooth back surface of the cogged free fall protection member 110 may be provided with markings showing the position of the landing 112 and the number of the landing. The markings may comprise the position of the landing 112 as well as the position of the door zone 112A, 112B in both directions. An indicator 111 may further be provided, wherein the car is at the landing when the marking 112 of the landing on the free fall protection member 110 coincides with the indicator 111. The indicator 111 may be realized with a wire passing in a transverse direction over the free fall protection member 110.

The marking of the position of the landings 112 on the free fall protection member 110 may advantageously be made when the car is loaded with a load corresponding to 50% of the nominal load of the car. The error caused by the change in the length of the free fall protection member 110 will thus be halved. The elevator may be started at the site for in order to check that the car stops at each landing in a correct position i.e. so that the sill of the car and the sill of the landing are at the same vertical level. The car may then be loaded with a load corresponding to 50% of the nominal load of the car. The information relating to the landing may then be marked on the free fall protection member 110 one landing at a time starting from the bottom of the shaft. The information to be marked on the free fall protection member 110 at each landing at the indicator 111 is the position of the landing i.e. the position in which the sills are at the same vertical level, the number of the landing, the limits of the door zone above and below the position of the landing.

The marking on the back side of the free fall protection member 110 eliminates the need for the service person to check at which landing the car is before starting the rescue operation. The service person may determine the position of the car and the number of the nearest landing from the back side of the free fall protection member 110. The service person may also, during the movement of the car, be able to determine from the back side of the free fall protection member 110 when the car is within the door zone by comparing the position of the indicator 111 and the position of the markings on the back side of the free fall protection member 110 with each other.

The embodiments in the figures use an encoder 200 in connection with the traction sheave 33 for measuring the rotational speed of the traction sheave 33 and an encoder 250 in connection with one of the free fall protection pulleys 120, 130 for measuring the speed of the free fall protection pulley 120, 130. Comparison of the two speed signals will provide valuable information. If the measured speeds correspond to one another, then the encoders are working properly and the hoisting member 42 is not slipping on the traction sheave 33.

The hoisting system of the elevator and/or the free fall protection system of the elevator may be provided with at least one speed detector. The speed detector may be based on electronic devices e.g. it may be based on one or more acceleration sensors or it may be based on encoder data. The speed detector may on the other hand be based on mechanical devices e.g. a roller acting on the car guide rail 25. One or more acceleration sensors may be positioned in connection with the car 10 and/or in connection with the counterweight 41.

The free fall protection controller 260 may activate the free fall protection brakes 150, 160 e.g. in the following events:

The speed of the free fall protection member 110 is too high.

The speed of the car 10 and/or the counterweight 41 is too high.

The car 10 does not decelerate fast enough when the car 10 approaches an obstacle in the shaft 20, such as an end of the shaft 20 or another car 10 moving in the shaft 20.

The car 10 does not decelerate fast enough during a normal emergency stop of the elevator.

The free fall protection brake devices 150, 160 may also be activated manually e.g. in case the machinery brakes 34A, 34B are to be serviced.

The free fall protection brake devices 150, 160 may be released manually when the car 10 is to be moved in a situation in which the free fall protection controller 260 is not working or there is a blackout.

The free fall protection controller 260 may be configured so that it controls the free fall protection brake devices 150, 160 gradually.

There is no need to dimension the free fall protection brake devices 150, 160 for a free fall situation in the same way as the safety gears must to be dimensioned. It is enough to dimension the free fall protection brake devices 150, 160 so that they can stop the absolute maximum imbalance of the elevator. The free fall protection member 110 will catch the falling car 10 in the event of the hoisting member 42 breaking loose.

An elevator using shortened buffers in the pit must be provided with an Emergency Terminal Speed Limiting (ETSL) system. The ETSL system will disconnect the electric supply to the machinery brakes and to the motor in case the deceleration of the car is not enough when approaching the end of the shaft. The ETSL system should secure that the car 10 never bumps against the buffer with a speed over 3 m/s. This should eliminate the need for a jump preventing lock-down apparatus in the elevator. The ETSL system might not in all circumstances be able to eliminate overspeed at the end of the shaft. The friction between the traction sheave and the hoisting member might not be big enough or the torque produced by the machinery brake might not be big enough for eliminating overspeed at the end of the shaft. The free fall protection brake devices 150, 160 may be dimensioned so that the combined deceleration of the machinery brakes 34A, 34B and the free fall protection brakes 150, 160 stays within the safe limits in terms of passenger safety and elevator safety regulations. The free fall protection system forms thus a new, additional protection layer, independent of the ETSL system, for preventing driving at a too high speed on the buffers. The free fall protection system decelerates and stops the car in case the ETSL system fails.

The hoisting member 42 may be formed of at least one belt having a generally flat cross section or at least one rope having a generally round cross-section. The hoisting member 42 may be formed of several belts or ropes running in parallel. The material of the belt or rope may be steel and/or fibre reinforced polymer.

The hoisting member 42 may on the other hand be formed of at least one flat or round rope or cable made of carbon fibres sealed in high-friction polymer. The hoisting member 42 may be formed of several flat or round ropes or cables made of carbon fibres sealed in high-friction polymer running in parallel.

The free fall protection member 110 may also be formed of at least one belt having a generally flat cross section, the belt being provided with cogs. The free fall protection member 110 may be formed of several belts running in parallel. The material of the belt may be fibre reinforced polymer e.g.

carbon fibres sealed in high-friction polymer.

Flat ropes made of carbon fibres sealed in high-friction polymer are sold e.g. under the trade name KONE UltraRope®.

The use of the invention is not limited to the elevator disclosed in the figures. The figure shows an elevator with a 1:1 suspension ratio and an elevator with a 2:1 suspension ratio, but the invention may be used in elevators with any suspension ratio. The invention can be used in any type of elevator e.g. an elevator comprising a machine room or lacking a machine room. The counterweight could be positioned on either side wall or on both side walls or on the back wall of the elevator shaft. The drive, the motor, the traction sheave, and the machine brake could be positioned in a machine room or somewhere in the elevator shaft. The car guide rails could be positioned on opposite side walls of the shaft or on a back wall of the shaft in a so-called ruck-sack elevator.

It will be obvious to a person skilled in the art that, as the technology advances, the inventive concept can be implemented in various ways. The invention and its embodiments are not limited to the examples described above but may vary within the scope of the claims.

1. An elevator comprising
a car, a counterweight, a hoisting member connecting the car with the counterweight, a hoisting machinery comprising a motor, a traction sheave and a machinery brake, and a free fall protection system comprising
a free fall protection member connecting the car with the counterweight over at least two separate free fall protection pulleys,
at least one free fall protection brake acting on at least one of the at least two free fall protection pulleys,
a free fall protection controller for controlling the at least one free fall protection brake, wherein
the pre-tensioning of the free fall protection member is at least 50% smaller than the pre-tensioning of the hoisting member so that the car and the counterweight are supported by the hoisting member in normal operation and by the free fall protection member only in a situation in which the hoisting member support fails,
wherein
the free fall protection member is formed of at least one cogged belt,
each free fall protection pulley is formed of a cogged pulley mating with the cogged belt.

2. The elevator as claimed in claim 1, wherein a speed detector is arranged in connection with one of the free fall protection pulleys and/or the car and/or the counterweight for measuring the speed and/or the acceleration and/or the deceleration of the car and/or the counterweight, the free fall protection controller being arranged to activate the at least one free fall protection brake when an abnormal speed and/or acceleration and/or deceleration is detected.

3. The elevator as claimed in claim 1, wherein the machinery brake is arranged to be de-activated and the at least one free fall protection brake is arranged to be activated when the car has stopped at a landing, the hoisting machinery is arranged to relevel the car at the landing, wherein the small pre-tensioning of the free fall protection member allows stretching of the free fall protection member during the relevelling of the car so that relevelling of the car with the hoisting machinery is possible.

4. The elevator as claimed in claim 1, wherein the at least one free fall protection brake is arranged to back-up the machinery brake for reaching a desired deceleration of the car when the car approaches an end of the shaft.

5. The elevator as claimed in claim 1, wherein the at least one free fall protection brake is arranged to operate in parallel with the machinery brake, a constant portion of the deceleration torque being produced with the machinery brake and an adjustable portion of the deceleration torque being produced with the at least one free fall protection brake so that the maximum deceleration allowed for of the car is not exceeded in any circumstances.

6. The elevator as claimed in claim 1, wherein a mechanical interface is arranged between a shaft of a free fall protection pulley and a shaft of the motor for connecting and disconnecting the free fall protection pulley to the motor, the motor being arranged to rotate the free fall protection pulley for moving the car stuck between landings to the nearest landing,

7. The elevator as claimed in claim 1, wherein a shaft of the free fall protection pulley is arranged to be connected to a mechanical lever, the mechanical lever being arranged to rotate the tree fall protection pulley for moving the car stuck between landings to the nearest landing.

8. The elevator as claimed in claim 1, wherein a chain block is arranged in the vicinity of the free fall protection pulleys, a clamp being attached to the free fall protection member between the free fall protection pulleys, the chain block extending between the clamp and a stationary frame construction of the elevator, the free fall protection member being moved with the chain block for moving the car stuck between landings to the nearest landing.

9. The elevator as claimed in claim 1, wherein a rescue brake opening switch is provided in the maintenance access panel or in the machine room for opening the at least one free fall protection brake and the machinery brake in a rescue situation.

10. The elevator as claimed in claim 1, wherein a backside of the free fall protection member is provided with markings for each landing, an operator executing a manual rescue operation being able to determine the initial position of the car stuck between landings as well as the movement of the car from said marking so that the car can be stopped at the nearest landing.

11. The elevator as claimed in claim 1, wherein a first speed detector is arranged to measure the speed of the traction sheave and a second speed detector is arranged to measure the speed of the free fall protection sheave, a discrepancy in the output of the first speed detector and the output of the second speed detector indicating slipping of the hoisting member on the traction sheave.

12. A method for controlling an elevator, the elevator comprising
a car, a counterweight, a hoisting member connecting the car with the counterweight, a hoisting machinery comprising a motor, a traction sheave and a machinery brake, and a free fall protection system comprising
a free fall protection member connecting the car with the counterweight over at least two separate free fall pulleys,
at least one free fall protection brake acting on at least one of the at least two free fall protection pulleys, wherein
the pre-tensioning of the free fall protection member is at least 50% smaller than the pre-tensioning of the hoisting member so that the car and the counterweight are supported by the hoisting member in normal operation and by the free fall protection member only in a situation in which the hoisting member support fails,
a free fall protection controller for controlling the at least one free fall protection brake,
the method comprising
activating the at least one free fall protection brake with the free fall protection controller to stop the movement of the free fall protection member and thereby also the movement of the car and/or the counterweight when the hoisting member support fails.

13. The method as claimed in claim 12, further comprising measuring the speed and/or the acceleration and/or the deceleration of the car and/or the counterweight with a speed detector arranged in connection with one of the free fall protection pulleys and/or the car and/or the counterweight, the free fall protection controller being arranged to activate the at least one free fall protection brake when an abnormal speed and/or acceleration and/or deceleration is detected.

14. The method as claimed in claim 12, further comprising de-activating the machinery brake and activating the free fall protection brake when the car has stopped at a landing, using the hoisting machinery for relevelling of the car at the landing, wherein the small pre-tensioning of the free fall protection member allows stretching of the free fall protection member during the relevelling of the car so that relevelling of the car with the hoisting machinery is possible.

15. The method as claimed in claim 12, further comprising using the at least one free fall protection brake as a back-up for the machinery brake for reaching a desired deceleration of the car when the car approaches an end of the shaft.

16. The method as claimed in claim 12, further comprising operating the at least one free fall protection brake in parallel with the machinery brake, a constant portion of the deceleration torque being produced with the machinery brake and an adjustable portion of the deceleration torque being produced with the at least one free fall protection brake so that the maximum deceleration allowed for the car is not exceeded in any circumstances.

17. The method as claimed in claim 12, further comprising connecting a shaft of a free fall protection pulley and a shaft of the motor with a mechanical interface connecting and disconnecting the free fall protection pulley to the motor, the motor being used for rotating the free fall protection pulley to move the car stuck between landings to the nearest landing.

18. The method as claimed in claim 12, further comprising connecting a shaft of the free fall protection pulley to a mechanical lever, the mechanical lever being arranged to rotate the free fall protection pulley for moving the car stuck between landings to the nearest landing.

19. The method as claimed in claim 12, further comprising arranging a chain block in the vicinity of the free fall protection pulleys, attaching a clamp to the free fall protection member between the free fall protection pulleys, the chain block extending between the clamp and a stationary frame construction of the elevator, moving free fall protection member with the chain block to move the car stuck between landings to the nearest landing.

20. The method as claimed in claim 12, further comprising providing a rescue brake opening switch in the maintenance access panel or in the machine room for opening the at least one free fall protection brake and the machinery brake in a rescue situation.

21. The method as claimed in claim 12, further comprising measuring the speed of the traction sheave with a first speed detector and measuring the speed of the free fall protection pulley with a second speed detector, a discrepancy in the output of the first speed detector and the output of the second speed detector indicating supping of the hoisting member on the traction sheave.

22. The method as claimed in claim 12, further comprising providing a backside of the free fall protection member with markings for each landing, wherein an operator executing a manual rescue operation is able to determine the initial position of the car stuck between landings as well as the movement of the car from said marking so that the car can be stopped at the nearest landing.
